(19) United States
(12) Patent Application Publication
(10) Pub. No.: US 2012/0145561 A1
(43) Pub. Date: Jun. 14, 2012

(54) Device for Measuring at Least One Property of Water

(75) Inventors: Yves De Coulon, Thielle-Wavre (CH); Carine Beriet, Peseux (CH); Fabien Nguyen, Les Geneveys-Sur-Coffrane (CH); Roland Gentsch, Hauterive (CH); Albin Monsorez, Montreuil (FR)

(73) Assignee: VEOLIA WATER SOLUTIONS & TECHNOLOGIES SUPPORT, Saint Maurice Cedex (FR)

(21) Appl. No.: 13/382,693

(22) PCT Filed: Jul. 6, 2010
(86) PCT No.: PCT/EP2010/059671

§ 371 Date: Feb. 29, 2012

(30) Foreign Application Priority Data
Jul. 6, 2009 (FR) 0954669

(51) Int. Cl. G01N 27/26; G01N 27/49

(52) U.S. Cl. 205/778.5; 204/416

(57) ABSTRACT

The invention relates to a device for measuring at least one physico-chemical parameter of water, said device including a means for measuring the concentration of active chlorine in the form of hypochlorous acid HOC1 in said water. According to the invention, said means for measuring the chlorine concentration in the form of hypochlorous acid HOC1 includes first (21) and second (22) amperometric sensors for detecting chlorine in the form of hypochlorous acid HOC1, each outputting a signal, said two amperometric chlorine sensors (21, 22) having a single common reference electrode (25) and being connected to a double potentiostat, characterised in that said invention includes a means for simultaneously implementing said first (21) and second (22) amperometric sensors, and in that said invention includes a means for measuring a difference between the signals output by said two sensors (21, 22).

### 1. FIELD OF THE INVENTION

The field of the invention is that of techniques for measuring physico-chemical parameters. The invention can be applied especially but not exclusively in the context of production and/or distribution networks for drinking water, especially for use in food items. It can also be applied for example in the field of the treatment of water in swimming pools, spas, jacuzzis, industrial processes, fish breeding, waste-water, desalinated water, ballast water for navigation, etc.

More specifically, the invention pertains to the designing and manufacture of probes and processes for the online measurement of several key parameters representing the quality of the water and the state of a water distribution network and of its installations, including chlorine content and water pressure.

In practice, the measurement of the chlorine present in water gives a relatively precise indication of the quality of this water. Indeed, the chlorine content of distributed drinking water must be low enough not to affect its flavor but high enough to ensure that no bacterial growth is observed in it.

### 2. PRIOR ART AND DRAWBACKS OF THE PRIOR ART In the field of water treatment, the quality of water, whether treated or to be treated, is commonly checked in order to verify the efficiency of the treatment and/or optimize the treatment of water as a function of the operating conditions.

Probes are generally used to measure physico-chemical parameters representing the quality of the water, especially the quality of treated water.

Multiple probes are known, comprising a large number of sensors, generally more than ten, used to collect a multitude of pieces of information representing the quality of water treated.

These probes generally comprise a chlorine sensor. In order to determine the chlorine content of the water analyzed, the type of chlorine sensor used makes it necessary to measure its pH.

The pH sensors contain an electrolyte. The quantity of this electrolyte regularly diminishes as and when the pH sensor is used. Thus, a pH sensor generally has a service life smaller than or equal to six months.

The implementation of this type of probe therefore gives rise to frequent maintenance campaigns to replace the electrolyte and recalibrate the probe. These probes thus have a relatively short service life.

These multiple probes also have the drawback of being relatively bulky. This hampers the ease with which they can be implemented. In particular, such probes take up an amount of space such that they cannot for example be implemented in a user's private drinking water distribution network.

In order to remedy the problem of the limited service life of these probes, other types of probes have been developed.

In particular, there is the known probe MESM 2405 commercially distributed by Silsens. This probe comprises a chlorine sensor and a temperature sensor.

This probe implements an amperometric chlorine sensor. This type of sensor does not require that the pH of the water be measured in order to determine its chlorine content. Thus, the measurement of the chlorine content of the water can be obtained without implementing any pH sensor.

The service life of this type of probe is therefore greater than that of the probes that implement pH sensors.

Besides, a probe of this kind is meant to be integrated into a water analyzer. A water analyzer is conventionally placed away from the water distribution network. It is connected to a bypass network which enables the taking of water for sampling from the water distribution network in order to analyze it. It is also connected to a network for discharging the sample of water.

This probe is therefore relatively complex to implement. In particular, it does not enable in-situ checks on the quality of water. Nor can it be implemented directly on a user's drinking water distribution network.

### 3. GOALS OF THE INVENTION

It is a goal of the invention to improve the amperometric chlorine sensor probes and the water quality measurement methods that use such probes.

In particular, it is a goal of the invention, in at least one embodiment, to provide a technique of this kind that enables the measurement of several parameters, especially at least one parameter representing the quality of water, by means of a multi-sensor probe.

More specifically, it is a goal of the invention, in at least one embodiment, to provide a technique of this kind that can be used to obtain a precise indication of the quality of water analyzed, especially its chlorine concentration.

It is another goal of the invention, in at least one embodiment, to implement a technique of this kind that requires little maintenance.

It is yet another goal of the invention, in at least one embodiment, to provide a technique of this kind that can be implemented in a compact way.

In particular, it is a goal of the invention, in at least one embodiment to provide a technique of this kind that can be used for in-situ measurement of the quality of water, for example directly on a drinking water distribution network.

It is yet another goal of the invention, in at least one embodiment, to provide a technique of this kind that is reliable.

### 4. SUMMARY OF THE INVENTION

These goals as well as others that shall appear here below are achieved according to the invention by means of a device for measuring at least one property of water comprising means for measuring the concentration of active chlorine in the form of hypochlorous acid HOC1 in said water, said means for measuring the chlorine concentration comprising first and second amperometric chlorine sensors, each delivering a signal, said two amperometric chlorine sensors having a single common reference electrode and being connected to a bipotentiostat,

said device comprising means for simultaneously implementing said first and second amperometric sensors,
said device further comprising means for measuring a difference between the signals delivered by said two sensors.

These goals as well as others that will appear here below are also achieved according to the invention by means of a method for measuring at least one property of water by the implementation of a device according to the invention, said method comprising:
a step for determining the concentration of active chlorine in the form of hypochlorous acid HOC1 in said water by means of said first and second sensors, and
a step for controlling said measurement of the concentration of active chlorine in the form of hypochlorous acid HOC1,
   said step for controlling comprising a step for monitoring the operational state of said sensors, said monitoring step comprising:
a first step for measuring a first piece of information representing the concentration of active chlorine in the form of hypochlorous acid HOC1 in said water by means of said first sensor and a second step for measuring a second piece of information representing the concentration of active chlorine in the form of hypochlorous acid HOC1 in said water by means of said second sensor, said first and second steps being implemented simultaneously,
a step for determining the difference between said first and second pieces of information representing said concentration;
a step for comparing the value of said difference with at least one reference value.

Thus, the invention relies on an innovative approach which consists in controlling the quality of water by measuring its active chlorine concentration and monitoring the operational state of the amperometric chlorine sensors implemented for this purpose. The monitoring consists more specifically in carrying out a dual measurement of the chlorine concentration by means of two distinct amperometric sensors and determining the difference between the two measurements in order to detect an operating anomaly in at least one of the sensors. The detection of an operating anomaly in the sensors is an indication of their level of age which enables a decision to be taken on their replacement.

The two chlorine sensors enable a dual measurement which may be furthermore analyzed:
at great frequency, every six seconds for example, to rapidly deliver alarms on the chlorine level (analysis of signals from the sensors filtered rapidly by high-pass filters; comparison of the signals delivered by each sensor with upper and lower threshold values and delivery of an alarm message indicating that the chlorine concentration is too high or too low);
at lower frequency, for example every six minutes, to determine the state of aging of the two chlorine sensors (analysis of signals delivered by each chlorine sensor filtered more slowly by low-pass filters; calculation of the mean chlorine concentration; calculating the difference between the signals delivered by each chlorine sensor and determining the level of aging of the sensors).

The technique of the invention thus makes it possible to derive maximum use of the chlorine sensors. Indeed, the chlorine sensors have a variable service live. Classically, chlorine sensors are implemented for a duration corresponding to their minimum service life so that it is always certain that there will be a sensor in working condition. Chlorine sensors are thus regularly changed. Their replacement can take place when they are still in working condition. This necessitates frequent action on the sensors and entails additional running costs.

The fact, according to the invention, of controlling the state of the sensors makes it possible to detect the precise instant at which one or both of the sensors is or are no longer in working condition. These sensors are replaced only at this instant. When only one of the chlorine sensors is defective, the chlorine concentration can continue to be measured by means of the other sensor. In this case, it is not obligatory to replace the sensors. The technique of the invention therefore enables maximum exploitation of the chlorine sensors, and makes it possible to postpone their replacement. It thus reduces the frequency of maintenance campaigns and accordingly increases the service life of a measurement device according to the invention.

Such an approach therefore leads to the possibility of installing a device according to the invention at a user's premises. It then becomes possible to have precise knowledge, at each water distribution point, of the level of quality of the water and makes it possible to detect problems if any in the distribution networks.

The fact that, according to the invention, the amperometric chlorine sensors are coupled to a bipotentiostat and share one common reference electrode has advantages.

This reduces the number of electronic components needed to implement them. For, conventionally, those skilled in the art wishing to use two amperometric sensors would use two potentiostats and two reference electrodes.

The fact according to the invention of limiting the number of components reduces the uncertainties of operation and reduces the space requirement of the device while at the same time improving its quality. In particular, the implementation of a reference electrode common to the two amperometric chlorine sensors ensures that the reference potential applied between the reference electrode common to the two amperometric sensors and the working electrode of each of these sensors is identical. Thus, if a disparity is detected between the two signals delivered by each of the sensors, it is not linked to a problem of supply to the sensors but to a malfunctioning of one of the amperometric sensors as such. This implementation thus limits the sources of malfunction in the amperometric sensors.

A device according to the invention preferably includes a sensor for measuring the pressure of said water.

The value of the pressure of the water gives an indication of the quality of the measurement of the chlorine concentration by an amperometric sensor. Indeed, the pressure of the water is an interfering factor liable to disturb the measurement of chlorine by amperometric techniques. A sudden variation in pressure, for example due to a break in a pipe or a water hammer could prompt errors in the measurement of the chlorine concentration. The measurement of the pressure associated with a measurement of the chlorine concentration can then make it possible to ensure that the value of the chlorine concentration measured conforms to reality and is not falsified by a sudden variation in pressure. This implementation thus prevents the untimely triggering of alarms.

A device according to the invention comprises means for measuring the conductivity of said water.

The value of the conductivity of the water gives an indication on the level of fouling of the device. This indication is used to assess the quality of the measurement of the chlorine concentration by means of an amperometric sensor.

Preferably, said means for measuring the conductivity of water include a conductivity sensor with four electrodes.

Indeed, the measurement of the conductivity of water determines the resistance of contact between the electrodes of the conductivity sensor and the water. The fouling of a device according to the invention is correlated with the fouling of the conductivity sensor which is itself correlated with the contact resistance.

The conductivity sensor is declared to be “fouled” when the contact resistance of the measuring terminals of this conductivity reaches a borderline value. The conductivity sensor is considered to be “clean” when the value of the contact resistance (CR) is approximately equal to twice the value of the shunt resistance (SR). Maximum fouling (100%) is defined when the value of the contact resistance (CR) is greater than or equal to three times the shunt resistance (SR). The measurement of conductivity from the measurement of the contact resistance has the advantage of not having any saturation effect. In other words, it is possible to know the contact resistance in both the upper and the lower scales of values with precision.

According to a preferred aspect of the invention, said amperometric chlorine sensors are sensors working with a low-frequency signal and said conductivity sensor is a sensor working with a high-frequency signal.

The chlorine and conductivity sensors are thus decoupled in terms of frequency. The signals delivered by the chlorine sensors and those delivered by the conductivity sensor do not disturb each other. This improves the quality of the device.

Preferably, a device according to the invention comprises a sensor for measuring the temperature of said water.

Since all the electrochemical measurements bring a redox couple into action, the temperature measurement corrects the electrical signal linked to a variation in the electrochemical kinetics. Indeed, the reaction mechanisms that lead to the measurement of concentration depend on the temperature and most frequently follow the Arrhenius Law. Thus, without taking account of the temperature variation, it is difficult to maintain a linear response of the sensor and obtain a response curve that represents the real concentration, whatever the temperature.

According to an advantageous characteristic, a device according to the invention comprises means for processing pieces of data delivered by said sensors, and means for the wire and/or radio transmission of said processed pieces of data.

A device according to the invention can thus be used for remote transmission of the pieces of data delivered by the sensors. These pieces of data can thus be analyzed remotely. The device therefore includes only means for processing (filtering, amplifying) and transmitting these pieces of data, the analysis means being placed at a distance. A device according to the invention thus takes up little space. Its electrical consumption is also reduced, thus limiting the frequency of the maintenance phases. All this contributes to easier implementation of the device according to the invention. In particular, such a device can be implemented directly on a user's drinking water distribution network.

Preferably, a device according to the invention comprises:
a body that houses said bipotentiostat, a voltage source, said processing means, and said transmission means;
a detachable head to which there is fixedly joined a printed circuit board on which said sensors are mounted; said detachable head being capable of being disconnected from said body.

Thus, when it is detected that at least one of the chlorine sensors is defective, the detachable head can be replaced easily, even by a non-technician, for example by the user himself or herself.

Said treatment means preferably comprise means for measuring and memorizing maximum, minimum and average values of the pieces of data delivered by said sensors.

This gives information on the consistency of the measurement with a limited number of information elements.

This is particularly valuable when the information elements are transmitted without wire link.

As mentioned further above, the invention also relates to a method for measuring at least one physico-chemical parameter of water that includes a control step.

Preferably, said control step includes a step for monitoring the level of fouling of said device, said step for monitoring the level of fouling comprising a step for measuring the conductivity of said water.

Advantageously, said control step comprises a step for measuring the pressure of said water.

Indeed, in the prior art techniques, the amperometric measuring device is plunged into an electrolyte and is separated from the liquid to be analyzed by a selective membrane letting through only the active chlorine in the electrolyte. This device has the following drawback: the flow of chlorine through the membrane depends on the difference in pressure between upstream and downstream relatively to the membrane. Thus, for an identical concentration in free chlorine in the medium to be measured, the changes in pressure upstream to the sensor modify the flow of active chlorine, and this leads to a variation in the chlorine concentration perceived by the sensor if he does not take account of pressure.

### 5. LIST OF FIGURES

Other features and advantages of the invention shall appear more clearly from the following description of a preferred embodiment given by way of a simple and non-exhaustive illustrator example, and from the appended drawings of which:

FIG. 1 is an exploded view of a device according to the invention;

FIG. 2 illustrates the coupling of two amperometric chlorine sensors;

FIG. 3 illustrates the mounting of a four-electrode conductivity sensor;

FIG. 4 is a block diagram of a device according to the invention;

FIG. 5 illustrates power supply charts of the sensors of a device according to the invention;

FIG. 6 illustrates charts for periods of analysis of the data delivered by the sensors of a device according to the invention;

FIG. 7 illustrates a schematic drawing for analyzing signals delivered by the chlorine sensors.

### 6. DESCRIPTION OF ONE EMBODIMENT OF THE INVENTION

6.1. Reminder of the Principle of the Invention

The general principle of the invention relies on an innovative approach in which the quality of water is controlled by measuring its active chlorine concentration and by monitoring the operating condition of the amperometric chlorine sensors implemented to this end. The monitoring consists more precisely in carrying out a dual measurement of the chlorine concentration by means of two distinct amperometric chlorine sensors and determining the difference between the two measurements in order to detect an operating anomaly in at least one of the sensors. The detection of an operating anomaly in the sensors is an indication of their age which makes it possible to take the decision to replace them.

The technique of the invention enables maximum use to be made of the chlorine sensors. It therefore makes it possible especially to reduce the frequency of the maintenance campaigns and accordingly to increase the service life of the measuring device according to the invention.

The dual measurement of active chlorine can also be associated with the measurement of conductivity and/or pressure so as to control the quality of the measurement of the chlorine concentration.

According to the invention, the amperometric chlorine sensors are coupled to a bipotentiostat and share a reference electrode in common. This reduces uncertainties of functioning and also reduces the amount of space needed by the measurement device while at the same time improving its quality.

6.2. Example of a Device According to the Invention

6.2.1. General Architecture

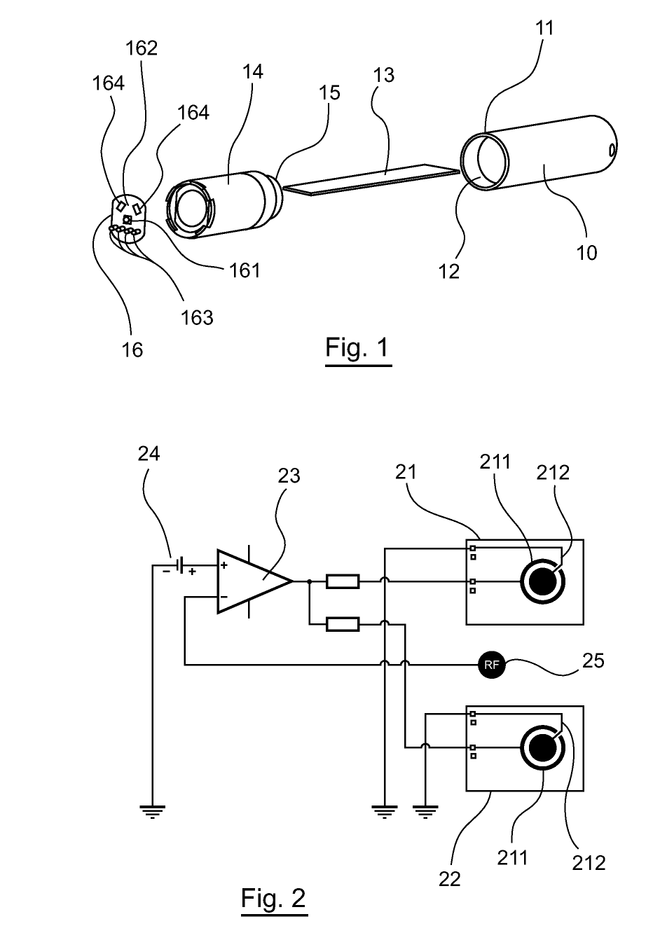

Referring to FIGS. 1 to 6, we present an embodiment of the measurement device according to the invention.

Such a device has a tubular hollow body 10 with an open end 11. A threaded part 12 extends from the open end 11 on to a part of the internal outline of the tubular body 10.

An electronic board 13 is housed inside the tubular hollow body 10.

A detachable head 14 is provided in order to be attached reversibly to the tubular body 10. Thus, at one of its ends, it has a threaded part 15 with a shape complementary to that of the threaded part 12.

A plane printed circuit board 16 is fixedly joined to the other end of the detachable head 14. A plurality of sensors is directly mounted on this printed circuit board 16 by a technique known as the COB (chip-on-board) technique.

6.2.2. Printed Circuit Board and Sensors

The printed circuit board 16 comprises a pressure sensor 161, a temperature sensor 162, a conductivity sensor 163, and two amperometric sensors 164 of active chlorine in the form of hypochlorous acid HOC1. The amperometric sensors of chlorine are three-electrode sensors well known to those skilled in the art. The comprise a working electrode 212, a reference electrode 25 and an auxiliary electrode 211. The three electrodes of each of the two chlorine sensors are connected to a common supply and polarization circuit, here below called a bipotentiostat, used to keep the potential of the working electrode of each chlorine sensor at a constant level. In other words, the bipotentiostat is used to deliver a constant current between the reference electrode and the working electrode of each sensor. This current reduces the chlorine present in the water into which the sensor is plunged. The reduction of the chlorine causes a current to pass between the working electrode and the auxiliary electrode of each chlorine sensor. This current is proportional to the concentration in active chlorine, in the form or hypochlorous acid, the water analyzed.

As shown in FIG. 2, the two chlorine sensors 21, 22 are coupled together to a bipotentiostat.

The bipotentiostat comprises a single operational amplifier mounted as a comparator. Indeed, it is a single potentiostat that supplies the two working electrodes 212 through resistors (equivalent to 10 kilo-ohms in this embodiment) and the reference electrode 25. Two integration chains are added for integrating the current flowing in the two auxiliary electrodes 211, this current being proportional to the active chlorine concentration in the water analyzed. The operational amplifier 23 receives a reference voltage at a first input 24 and a voltage signal coming from the reference electrode 25 at a second input, and delivers an output signal which is applied to the working electrode 212 of each chlorine sensor. These resistors, the value of which is equal to 10 kilo-ohms in this embodiment, limit the current and prevent excess voltage in the electrodes.

Each chlorine sensor also has an auxiliary electrode 211. In each of the working electrodes 212, the current is measured to determine the active chlorine concentration.

The conductivity sensor is a four-electrode sensor well known to those skilled in the art. It is therefore not described in greater detail here below.

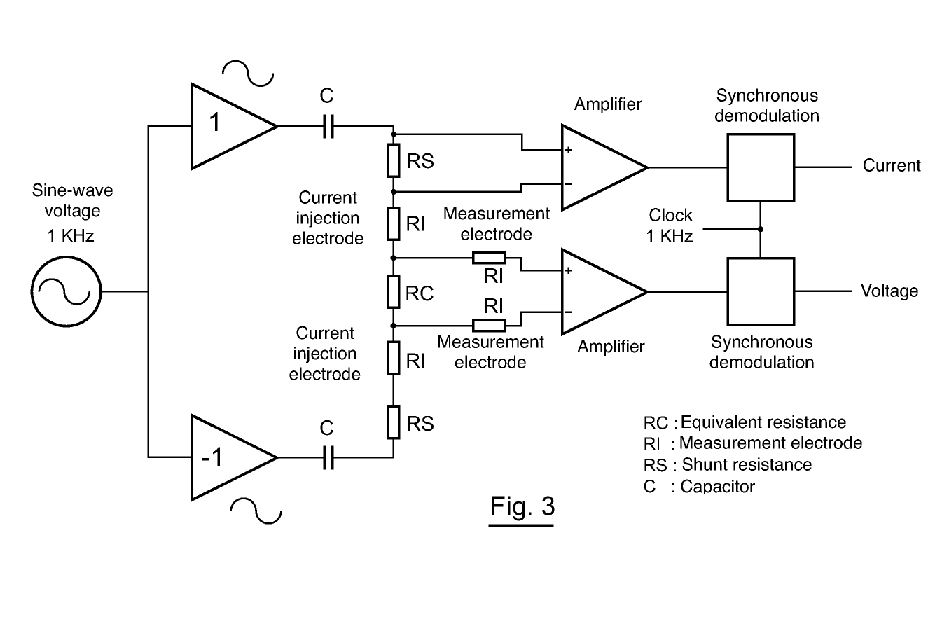

However, and as illustrated in FIG. 3, it may be recalled that such a conductivity sensor has two external electrodes and two internal electrodes. Its operating principle therefore consists of the application, between two external electrodes, of an alternating voltage and then the measurement of a voltage at the terminals of the two internal electrodes.

More specifically, a conductivity sensor works as follows. A generator of alternating voltage at high frequency for example at one kilohertz generates, through two measurement resistors SR known as shunt resistors, a current between two injection electrodes IR placed in an aqueous medium. After demodulation at the same frequency of one kilohertz, the voltage at the terminals of the shunt resistors SR, the value of which is known, and the voltage at the terminals of the measurement electrodes RI are measured. The conductivity of the water between the measurement terminals RI and the equivalent contact resistance CR can then be calculated. It is noted that the greater the value of the contact resistance CR in the aqueous medium, the greater will be the level of fouling of the device.

The pressure and temperature sensors are classic sensors well known to those skilled in the art. They are therefore not described in detail here below.

Electrical connectors are mounted on the printed circuit board 16. These connectors are provided to cooperate with connectors of complementary shape mounted on the electronic board 13 when the detachable head 14 is attached to the tubular body 10. These connectors provide the electrical connection between the sensors and the electronic board 13.

6.2.3. Electronic Board

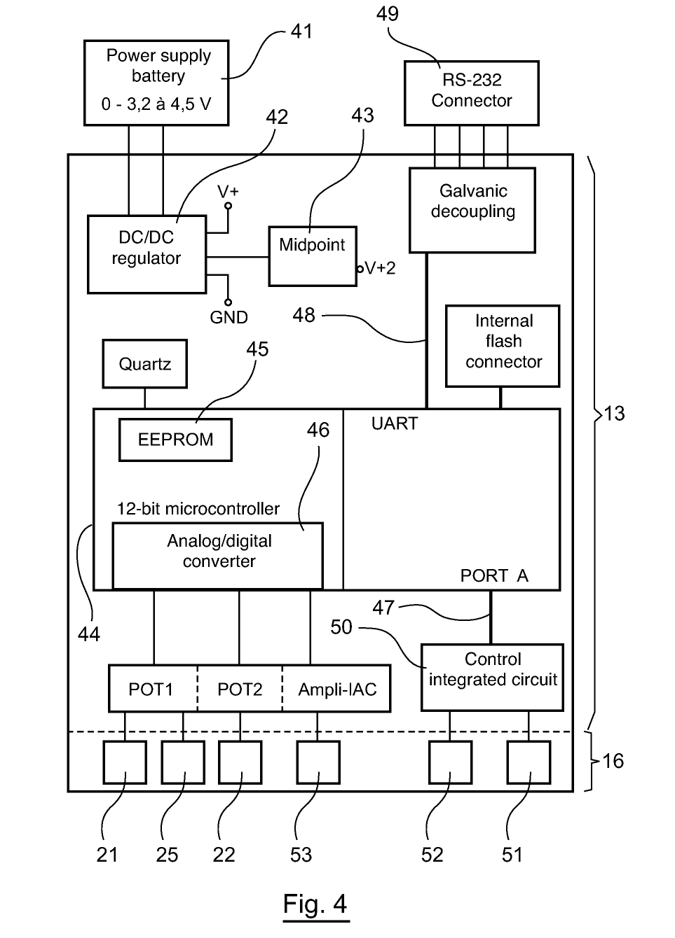

A description shall now be provided, referring to FIG. 4, of a particular embodiment of the electronic board 13. As illustrated, the electronic board 13 cooperates with the printed circuit board 16.

The electronic board 13 has a DC/DC type voltage regulator 42 used to power the different components mounted on the electronic board 13. In one particular embodiment this regulator 42 is powered by external powering means 41. For example, the powering means 41 comprise a battery (or a set of electrical cells) used to deliver voltage of 3 to 5 volts. The shape and dimensions of the battery are such that they enable it to be housed within the tubular hollow body 10.

The electronic board has a midpoint regulator 43, for example with a value of 1.5 volts, cooperating with the voltage regulator 42.

The electrical board also has a microcontroller 44 whose operation is clocked by a quartz clock. The microcontroller 44 comprises:
an EEPROM type memory 45 in which are stored pieces of data coming from the different sensors of the printed circuit board 16;
conversion means to convert the pieces of data coming from the chlorine sensors 21, 22 and the conductivity sensor 53 into pieces of data that can be exploited by the microcontroller 44. It can also be noted that the microcontroller can control the chlorine and conductivity sensors through the conversion means. These conversion means include for example analog/digital converters and/or digital/analog converters 46. In one particular embodiment, the conversion means 46 comprise three inputs. Two of its inputs are connected to the bipotentiostat POT1, POT2 to which the two amperometric chlorine sensors 21, 22 and the reference electrode 25 are connected. These two inputs respectively make it possible to receive the current delivered by each of the two chlorine sensors which is proportional to the chlorine concentration in the water. The third input of the analog/digital converter is connected to the output of an amplifier whose input is connected to the conductivity sensor 53,
a synchronous serial port 47 through which the microcontroller communicates with the pressure sensor and the temperature sensor. In one particular embodiment, the electronic board 13 has a control circuit 50 mounted between the microcontroller and the pressure and temperature sensors. This control circuit manages the working of the membrane pressure sensor. The deformation of the membrane, due to the pressure of the water analyzed, is measured by piezo-resistors in a Wheatstone bridge. To this end, the control circuit is used to inject a current into the Wheatstone bridge and measure the voltage imbalance of the bridge, which is proportional to the pressure of the water.
an asynchronous serial port 48 through which the microcontroller communicates with external communications means, connected for example via a connector 49, for example of the RS-232 type. In one particular type, the electronic board 13 has galvanic insulation means mounted between the microcontroller and the connector 49.
an internal flash connector which enables the software of the microcontroller 44 to be loaded numerous times.

It is also possible to provide for galvanic decoupling means at the pressure and temperature sensors.

A switch, not shown, is used to power on the device.

Electrical connectors are mounted on the electronic board 13. These connectors are designed to cooperate with connectors of complementary shape mounted on the printed circuit board 16, when the detachable head 14 is attached to the tubular body 10.

6.3. Working of a Device According to the Invention

6.3.1. General Operation

A device according to the invention can be directly connected to a drinking water distribution pipe in a user's home. In particular, it can be fixedly joined thereto in such a way that the head of the probe is plunged into the water flowing in the pipe.

When the device is started up by actuation of the switch, the microcontroller 44 triggers the activation of the sensors of chlorine, conductivity, pressure and temperature.

In the embodiment illustrated in FIG. 4, the chlorine sensors work with low-frequency signals ranging from 1 to 5 Hz and preferably in the range of 3 Hz, and the conductivity sensor works with signals of higher frequency ranging from 500 to 5000 Hz, preferably 800 to 1200 Hz. The chlorine and conductivity sensors are thus frequency-decoupled. This prevents the signals sent out by the chlorine sensors and by the conductivity sensors from being mutually disturbed.

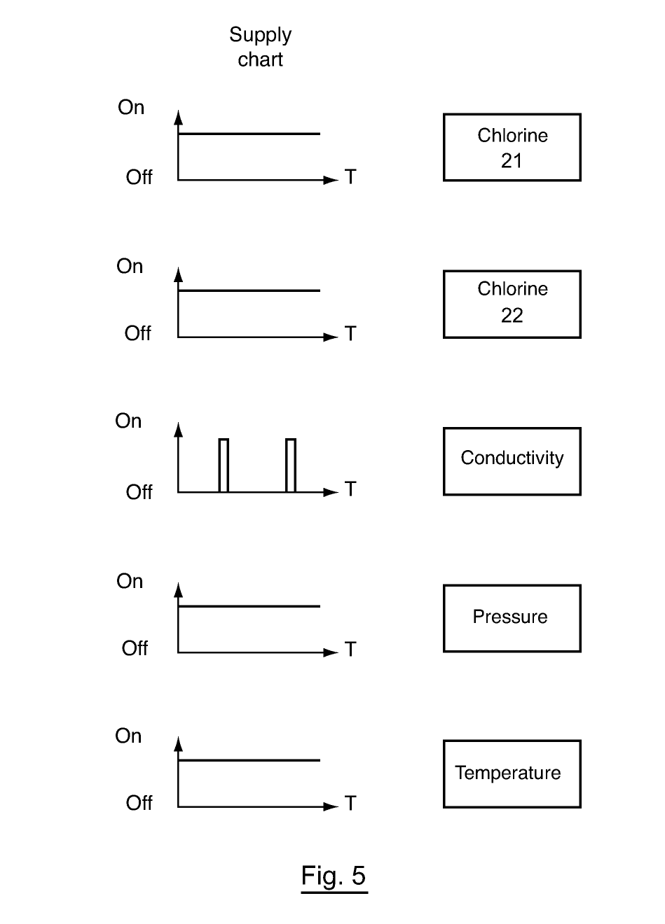

As shown in FIG. 5, the two chlorine sensors (chlorine 21 and chlorine 22), the temperature sensor and the pressure sensor are supplied with current continuously. The conductivity sensor is by contrast supplied periodically. This reduces the negative effects of the conductivity sensor which may be responsible for a noise on the pressure sensor and is energy-intensive in its implementation.

Each of the amperometric chlorine sensors is used to measure a voltage representing the concentration of active chlorine, in the form of hypochlorous acid, in the water analyzed.

The conductivity sensor measures voltage which represents the conductivity of the water analyzed at the detachable head.

The signals delivered by the chlorine sensors and the conductivity sensor are transmitted to the conversion means 46 of the microcontroller and then processed by it. The signal delivered by the pressure and temperature sensors are also transmitted to the conversion means of the microcontroller and then processed by it.

The microcontroller filters and amplifies the signals delivered by the chlorine sensors and by the conductivity sensor. It also filters and amplifies the signal delivered by the pressure sensor and the temperature sensor. The filter which, in this embodiment, is a low-pass filter, makes it possible to take an average of a certain number of measurements. This eliminates high-frequency noise and gives the possibility of knowing the variance of the signal.

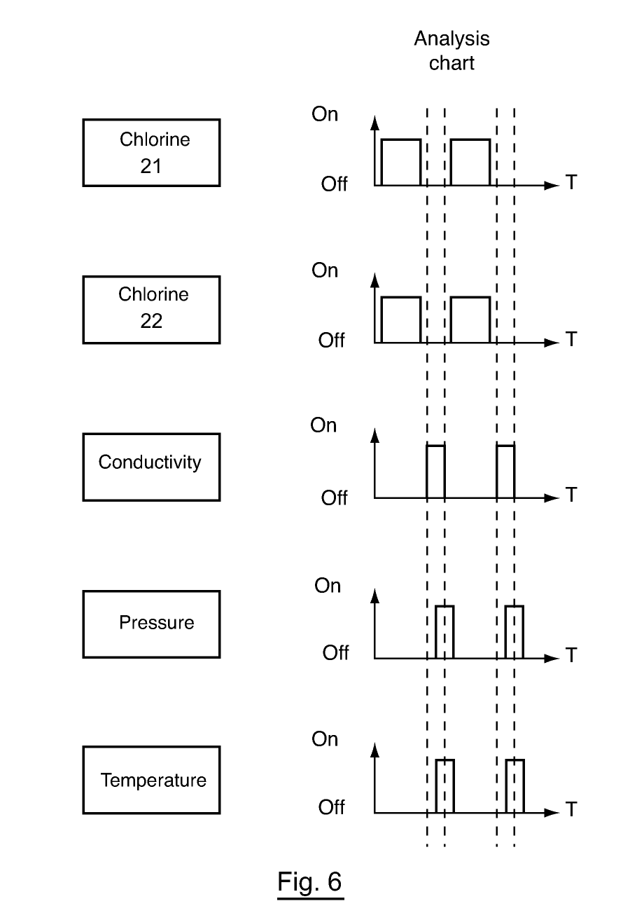

FIG. 6 illustrates a sequence of alternating operation of the different sensors and the processing by the microcontroller of signals coming from the different sensors. In particular, the signals delivered by the two chlorine sensors are analyzed simultaneously. The signals delivered by the conductivity sensor are analyzed while the analysis of the signals of the chlorine sensors is suspended. The signals delivered by the pressure and temperature sensors are analyzed simultaneously, outside the periods of analysis of the signals of the chlorine sensors, and in overlapping the periods during which the signals from the conductivity sensor are analyzed. This limits analog couplings by the use of time multiplexing and limits digital couplings by the use of frequency multiplexing and analysis multiplexing in the microcontroller between the different signals from the sensors.

There are different modes of acquiring measurements whose frequency may range from six seconds to one hour. In a normal mode, during a period of ten minutes, the microcontroller collects and processes a signal sent by each sensor. In one variant, a turbo mode may be activated. In this mode, the microcontroller collects and processes the signals sent by each sensor within a period of one minute.

In one embodiment, the microcontroller makes a calculation, every hour, of the average value of each signal sent by the sensors during the preceding hour. For a duration of 24 hours, it memorizes the average, maximum and minimum values of the signals sent by each of the sensors during the past hour of operation.

The pieces of information processed and stored are transmitted to the transmission means of the microcontroller. The microcontroller then transmits these converted and processed pieces of information by means of a wired serial bus which may be of the RS232 type operated for example under a MODBUS protocol.

These pieces of information are transmitted either:
locally to a controller or PC, directly connected to the wire link, operated by an operator or any other local user;
locally to a radio communications system using a chosen and appropriate protocol, for example of the GSM or GPRS type, which sends this data to a remote central server for analysis by an expert service (for example, a drinking water supplier) in a remote centralized manner at a distance from the multi-sensor probe.

Several frequency and communications modes may be envisaged: for example on-clock mode and on-event mode.

On-clock mode: the frequency of transmission of the information may vary from one hour to one day.

On-event mode: for example, in the event of detection of a quality of water below the predetermined threshold or the detection of a malfunction in the sensors, the probe passes into turbo mode and, of its own accord, sends a message containing the data outside the planned periods.

6.3.2. Implementation of the Chlorine Sensors

Each chlorine sensor enables the measurement of a voltage representing the active chlorine concentration of the water analyzed.

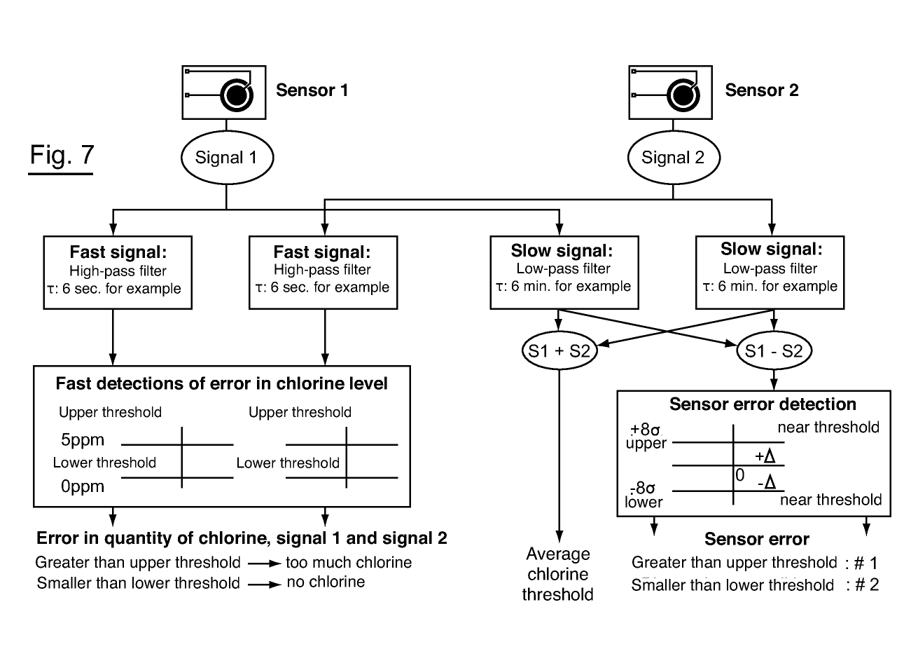

The implementing of two chlorine sensors makes it possible to monitor their state of operation according to the principles shown in FIG. 7.

The signal 1 delivered by the chlorine sensor 21 and the signal 2 delivered by the chlorine sensor 22 are filtered by a low-pass filter and analyzed at low frequency (for example every six seconds). These signals are compared with upper and lower thresholds of chlorine concentration by the microcontroller. This microcontroller can then, for each sensor, deliver a piece of information of the “excess chlorine” or “insufficient chlorine” type depending on whether the value measured is above or below the threshold. This implementation can swiftly trigger alarms for chlorine levels outside the norms.

The value of the upper and lower thresholds of concentration of active chlorine dissolved in water are defined according to the type of application, the country, and/or the region in which the sensor will be used. For example, for an application in swimming pool water in France, the upper threshold could be set at 5 ppm of active chlorine dissolved in water. In the case of an application to drinking water in France, the upper and lower thresholds could be set respectively at 0.2 ppm or 0.3 ppm of active chlorine dissolved in water when the sensor is placed on the piping situated in proximity to the place of consumption of the measured drinking water, while the upper and lower thresholds could respectively be 0.5 ppm and 0.7 ppm of active chlorine dissolved in water, when the sensor is placed on the pipe at the exit from the drinking-water production plant.

The signal 1 delivered by the chlorine sensor 21 and the signal 2 delivered by the chlorine sensor 22 are also filtered by a high-pass filter and analyzed at greater frequencies (for example every six minutes). These signals are added up by the microcontroller so that it can transmit a signal representing the average chlorine concentration measured by the two sensors. These signals are also subtracted from one another by the microcontroller in order to detect an operating anomaly in the chlorine sensors.

In particular, the microcontroller computes the difference between the first signal 1 delivered by a first chlorine sensor 21, and the second signal 2 delivered by a second chlorine sensor 22. The value of this difference is then compared by the microcontroller with an upper and a lower reference value. In this embodiment, the upper value is equal to 8 sigma and the lower value is equal to −8 sigma. When the difference is greater than the upper value, the signal delivered by the second sensor is faulty. When the difference is below the lower value, the signal delivered by the first sensor is faulty. In both cases, the detachable head needs to be replaced.

The monitoring of the chlorine sensors can be optimized. To this end, the microcontroller can analyze the variations if the difference computed relatively to the mean difference, for example over the last ten measurements. This variation is called noise.

When the noise is equal to zero, it is deduced therefrom that no signal is being transmitted by the sensors: the device is undergoing a general breakdown. When the noise is twice as small as the average value, it is deduced therefrom that one of the sensors is not producing any signal. When the noise exceeds the upper or lower reference value, it is deduced therefrom that one of the two chlorine sensors or both of them are defective.

6.3.3. Information Transmitted by the Device

A device according to the invention delivers several pieces of information:
at least one piece of information representing the active chlorine concentration in water: it may be a filtered and amplified signal delivered by each chlorine sensor, or the sum of the filtered and amplified signals delivered by the two chlorine sensors;
a piece of information representing the conductivity of the water at the level of the detachable head: filtered and amplified voltage measured between the internal electrodes of the conductivity sensor;
a piece of information representing the temperature of the water: filtered and amplified voltage delivered by the temperature sensor;
a piece of information representing the pressure of the water: filtered and amplified voltage delivered by the pressure sensor;
at least one piece of information representing the state of the chlorine sensors: the difference between the filtered and amplified signals delivered by the two chlorine sensors and/or indication of the need to replace the detachable head.

In one variant, a piece of information representing the level of the charge of the battery can also be delivered.

These pieces of information are then converted into values of concentration, conductivity, pressure and temperature at the remote server. The fact of seeing to it that these conversions will not be done directly by the microcontroller reduces the electrical consumption of the measuring device and accordingly increases the period of time for which it can work without requiring a maintenance campaign.

The pieces of information transmitted are one (or two) values of active chlorine concentration in mg/L, a pressure in bars, a conductivity in micro-siemens, a temperature in ° C., an indicator of fouling (%) and of battery level from 0 to 10 units.

The probe transmits for example the following signals:
twice the value in code of active chlorine from −300 to 300 per step of 1 for −3 to 3 ppm of dissolved active chlorine;
from 100 to 600 per step of 1 for 100 to 600 micro-siemens;
from 0 to 10,000 per step of 1 for 0 to 10 bars;
from 0 to 400 per step of 1 for 0 to 40° C.;
from 320 to 450 per step of 1 for the value of the battery from 3.2V to 4.5V;
from 0 to 100 per step of 1 for a value of fouling of the conductivity sensor from 0 to 100%.

The voltage measured by each chlorine sensor is equal to 1.5 volts when the concentration of the chlorine in water is 0. This voltage increases to the maximum voltage of 3 volts when the chlorine concentration becomes non-zero. It is therefore possible, between 1.5 to 3 volts, to measure a chlorine concentration for example ranging from 0 to 300 ppm with adjustable sensitivity.

However, when the sensor is defective, or has a leakage current, the voltage delivered can drop to 1 volt for example or even less. This corresponds, in the computation program of the probe, to a negative “virtual” chlorine level, for example −200, or −2 ppm, which indicates an error of the sensor or of the measuring electrode.

The pieces of information transmitted from the device according to the invention to the receiver (for example a cell phone) are encoded in ASCII characters.

In one variant, it can be planned that the conversions will be done directly by the microcontroller.

In another variant, rather than transmitting a signal indicating the need to replace the detachable head, the probe will transmit the difference between the voltages delivered by the chlorine sensors and/or will transmit the noise. The remote server will convert this data into an indication of the need to replace the detachable head.

6.4. Example of a Method According to the Invention

A device according to the invention can be implemented in a method consisting in measuring the quality of water, for example drinking water.

A method according to the invention comprises a step for determining the concentration of active chlorine in the form of hypochlorous acid HOC1 in water by means of said first and second sensors. It also has the original feature of comprising a step for checking the measurement of the concentration of active chlorine in hypochlorous acid form.

The step for determining the chlorine concentration consists in collecting the signal representing the chlorine concentration that is transmitted by the device of the invention. This signal can be either a direct indication of the chlorine concentration in water or a signal proportional to this concentration (the sum of the voltages delivered by the two sensors) which, after conversion makes it possible to know the value of the chlorine concentration.

The control step comprises a step for monitoring the working condition of the sensors. As just explained, this monitoring step comprises:
a first step for measuring a first piece of information representing the concentration of active chlorine, in the form of hypochlorous acid HOC1, in water by means of a first chlorine sensor (the voltage delivered by this sensor) and a second step for measuring a second piece of information representing the concentration of active chlorine, in the form of hypochlorous acid HOC1, in water by means of a second chlorine sensor (the voltage delivered by this sensor), the first and second steps being implemented simultaneously,
a step for determining the difference between the first and second pieces of information representing the active chlorine concentration (computation performed by the microcontroller);
a step for comparing the value of the difference relatively to a lower reference value and an upper reference value (comparison made by the microcontroller).

As a reminder, when this difference is greater than the upper reference value, the signal delivered by the second sensor is faulty. When this difference is below a lower reference value, the signal delivered by the first reference sensor is faulty. In both these cases, the detachable head needs to be replaced: the device transmits a piece of information to this effect.

In one variant, the comparison of the difference and/or of the noise with the references could be done directly by an operator responsible for the control.

The technique of the invention thus makes it possible to achieve maximum use of the chlorine sensors. Indeed, the chlorine sensors have a variable service life. Classically, chlorine sensors are implemented for a duration corresponding to their minimum theoretical service life so as to be always sure of using a sensor in working condition. The chlorine sensors are thus regularly changed. This calls for frequent action on the sensors and entails additional running costs. Their replacement could also be done when they are still in working condition.

The fact, according to the invention, of checking the state of the chlorine sensors makes it possible to detect the precise instant at which they are no longer in working condition. They will therefore be replaced only at that instant. The technique of the invention therefore makes it possible to use the chlorine sensors to the maximum extent, and postpone their replacement. It therefore reduces the frequency of maintenance campaigns and accordingly increases the service life of a measuring device according to the invention.

Such an approach thus leads to the possibility of implanting a device according to the invention at a user's premises. It then becomes possible to have precise knowledge, at each water distribution point, of the level of quality of the water and to detect problems if any in the distribution networks.

In this embodiment, the control step furthermore comprises a step for monitoring the level of fouling of the device. This step for monitoring the fouling level comprises a step for measuring the conductivity of water.

The inventors have discovered that the conductivity of water at the detachable head gives an indication of the level of fouling of the device and therefore the level of quality of the pieces of information that it delivers. Thus, when the level of fouling of the device is high, the probability is high that the information it delivers on the chlorine concentration in water does not comply with reality.

The conductivity sensor is said to be “fouled” when the contact resistance of the measurement terminals of this conductivity reaches a borderline value. The conductivity sensor is considered to be “clean” when the value of the contact resistance (CR) is approximately equal to twice the value of the shunt resistance (SR). The maximum fouling (100%) is defined when the value of the contact resistor (CR) is greater than or equal to three times the value of the shunt resistance (SR).

In this embodiment, the control step includes a step for measuring the pressure of said water.

The inventors have indeed also discovered that the value of the pressure of water gives an indication on the quality of the measurement of the concentration of chlorine in water.

6.5. Advantages

The technique of the invention has numerous advantages.

In particular, its implementation limits the frequency of the maintenance campaigns. The service life of a device according to the invention is about one year whereas the service life of the prior art devices is rarely greater than six months. A device according to the invention can thus be installed directly in a user's home since the number of maintenance campaigns requiring intervention by a technician is reduced.

The technique of the invention also gives a compact measuring device. In particular, coupling the chlorine sensors together reduces the number of components included in the device. It is thus possible to have a device with a greater service life without in any way thereby increasing its space requirement. This also contributes to enabling the installation of a device according to the invention directly in a user's home.

The technique of the invention also provides a high level of precision. Monitoring the state of the chlorine sensors ensures the use of sensors in working condition. Coupling the two sensors together limits the number of electronic components implemented and therefore limits the uncertainty of the measurement of the chlorine. Controlling the level of fouling of the device also makes it possible to have a piece of information on the exactness of the measurement of the chlorine concentration. The measurement of the pressure is also an indication of the correctness of the measurement of the chlorine concentration.

1-12. (canceled)

13. A device for measuring at least one physicochemical property of water, comprising:
a. a set of chlorine sensing components for measuring the concentration of chlorine in the form of hypochlorous acid in the water, the set of chlorine sensing components including first and second amperometric sensors for sensing chlorine in the form of hypochlorous acid, each sensor operative to deliver a signal indicating a concentration of hypochlorous acid in the water;
b. a bipotentiostat operatively connected to the second amperometric sensors for providing electrical potential to the amperometric sensors;
c. a single reference electrode that is common to the first and second amperometric sensors; and,
d. a controller for detecting a difference between the signal delivered by the first amperometric sensor and the signal delivered by the second amperometric sensor.

14. The device of claim 13 further including one or more components selected from among a group of components that includes a sensor for measuring water pressure, a sensor for measuring water temperature, and a sensor for measuring water conductivity.

15. The device of claim 14 including a sensor that includes four electrodes for measuring water conductivity.

16. The device of claim 15 wherein the signals delivered by the amperometric sensors for sensing chlorine concentration are multiplexed at a first frequency with signals delivered by the sensor for measuring water conductivity at a second frequency, the first frequency being a low-frequency and the second frequency being a high-frequency.

17. The device of claim 16 including a sensor for measuring water temperature.

18. The device of claim 13 including an electronic board for receiving signals delivered by the set of chlorine sensing components and signals delivered by one or more components selected from among a group of components that includes a water pressure sensor, water temperature sensor, and water conductivity sensor; the electronic board further operative to generate processed data from the received signals; and the electronic board including a microcontroller comprising at least one port for external communication.

19. The device of claim 18 including:
a. a body for housing the bipotentiostat;
b. a voltage source for supplying power to the electronic board;
c. a head detachable from the body;
d. a printed circuit board attached to the head, and wherein the sensors are mounted on the printed circuit board.

20. The device of claim 18 including one or more detectors, each detector for detecting one or more signal values selected from among a group of signal values including a maximum, a minimum of an average value.

21. The device of claim 13 including at least one high pass filter and at least one low pass filter for receiving signals produced by the two amperometric sensors.

22. The device of claim 21 wherein the low pass filter enables a determination of a faulty amperometric sensor; and wherein the high pass filter enables a detection of a chlorine concentration outside of a selected range.

23. The device of claim 14 wherein the device includes at least one conductivity sensor for generating conductivity signals; and wherein the device is operative to sequentially generate the chlorine signals produced by the amperometric sensors and the conductivity signals produced by the conductivity sensor.

24. A method of measuring at least one physiochemical property of water comprising:
a. acquiring a first value of chlorine concentration in the water from a signal delivered by a first amperometric sensor and substantially simultaneously acquiring a second value of chlorine concentration in the water from a signal delivered by a second amperometric sensor;
b. determining a difference between the first value and the second value; and,
c. utilizing the difference to detect whether the first or second amperometric sensor is faulty.

25. The method of claim 24 including one or more steps selected from the steps of:
a. monitoring sensor fouling by sensing water conductivity; and,
b. measuring water pressure.
